(19) United States
(12) Patent Application Publication
(10) Pub. No.: US 2015/0161629 A1
(43) Pub. Date: Jun. 11, 2015

(54) RETAIL OPTIMIZATION FOR MARKDOWN

(71) Applicant: SUDHIR VERMA, Gurgaon (IN)

(72) Inventor: SUDHIR VERMA, Gurgaon (IN)

(21) Appl. No.: 14/100,014

(22) Filed: Dec. 9, 2013

(51) Int. Cl. G06Q 30/02

(52) U.S. Cl. CPC G06Q 30/0202; G06Q 30/0206

(57) ABSTRACT

Methods and system are disclosed that support optimization for markdown in retail domain to generate an optimized price for a product. The markdown optimization is mapped to a genetic algorithm. In one aspect, an initial population of candidate solutions initializes the execution of the genetic algorithm. Based on a fitness function associated with an objective, the genetic algorithm iteratively executes on the initial population of candidate solutions to compute a fitness score corresponding to each candidate solution. In another aspect, based on the fitness score, the candidate solutions are selected to breed or generate candidate solutions for next-generation. The genetic algorithm terminates when a termination condition is met and may generate a set of particularly desirable result set. In yet another aspect, particularly desirable result set is validated by applying constraints and the validated particularly desirable result set represents most desirable result set.

### BACKGROUND

Product lifecycle management in general includes price optimization for each period of a product's lifecycle periods. Typically. price optimization is achieved by combinatorial searches on large data of markdown percentages and duration of each markdown percentage associated with the product. Based on such searches, optimized price for the product may be determined. However, performing combinatorial searches may become an overhead in terms of efficiency and time consumed for such operations. Further, validating the determined optimized prices performed by the combinatorial searches may be challenging.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a system for generating an optimized result set for a problem, according to an embodiment.

FIG. 2 is an exemplarily graphical illustration of demand curves associated with a product, according to an embodiment.

FIG. 3A and FIG. 3B are flow diagrams illustrating a process for generating optimized markdown data, according to an embodiment.

FIGS. 4A-4B are block diagrams illustrating a one-point crossover on a pair of strings of chromosomes according to an embodiment.

FIGS. 5A-5B are block diagrams exemplarily illustrating a process of mutation, according to an embodiment.

FIG. 6 is a block diagram illustrating a process to generate optimized markdown data, according to an embodiment.

FIG. 7 is a block diagram of a computer system, according to an embodiment.

### DETAILED DESCRIPTION

Embodiments of techniques for retail optimization for markdown are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Retail businesses include retailers selling consumable products. Retailers may procure such consumable products, herein referred to as product or products, directly from manufacturers or suppliers, and sell the products to end users or customers for a profit. Such products may be sold via physical stores or online marketplaces. The objective of every retailer is to maximize profit on the products being sold. Profits can be maximized by strategically planning the sales of the product. The strategic planning of sales of the product may also include determining pricing of the product through the product lifecycle.

Lifecycle of a product may be associated with time. Certain products may be time sensitive, and strategically pricing the product for increasing sales during the lifecycle of the product may be important. For example, a retailer selling an air conditioning unit can maximize profit on the sales, when the air conditioning unit is sold at onset of summer season, in comparison to end of summer season. The lifecycle of the air conditioning unit is associated with the summer season. The retailer may strategically price the air conditioning unit between the onset and the end of summer season. The retailers' pricing strategy may depend on objective of sales. For instance, the objective may include maximizing profit on the sales or minimizing the number of air conditioning units before the end of summer season.

Based on the objective, the product price may be optimized or strategically offered at a discount price during the product life cycle. Optimizing price may be based on the time period associated with the product life cycle, which may be divided into short time intervals. Corresponding to each time interval, the price of the product may be optimized or marked down, or discounted. The percentage of discount offered may depend on various factors associated with the product. For example, the associated factors may include volume or number of units of inventory, elasticity of product, time interval corresponding to the product lifecycle, etc.

In an embodiment, a markdown is a retail activity wherein a store or group of stores sells remaining inventory of a product or group of products within a designated time period. The designated time period may be associated with the lifecycle of the product. Pricing during product discontinuation or towards the end of the product lifecycle may be referred to herein as markdown pricing. The markdown may be orchestrated using a markdown schedule. The markdown schedule includes a sequence of price cuts from actual price corresponding to the time intervals of the product lifecycle. While price is not required to change over time, price changes during a markdown period may be downward in discrete steps.

In an embodiment, markdown inventory or markdown products may generally be considered as perishable. Once the end of the markdown time interval is reached, the remaining inventory may have a salvage value. Salvage value of a product may refer to the price of the product once the designated time period is reached, which marks the end of the product lifecycle. For example, the salvage value for a perishable product at the end of the product lifecycle may be zero. Markdowns are generally based on heuristic rules or heuristic information associated with the product. For example, before the end of the markdown time interval, the product retailer might markdown product pricing thirty percent off on the actual price for the first three weeks, then a fifty percent off on the actual price for next two weeks, and so on.

In an embodiment, optimization may refer to a process of determination of a particularly desirable result among other results considered. Optimization may include a process of generating or creating or converging to a solution or set of solutions among other solutions that may be associated with a problem.

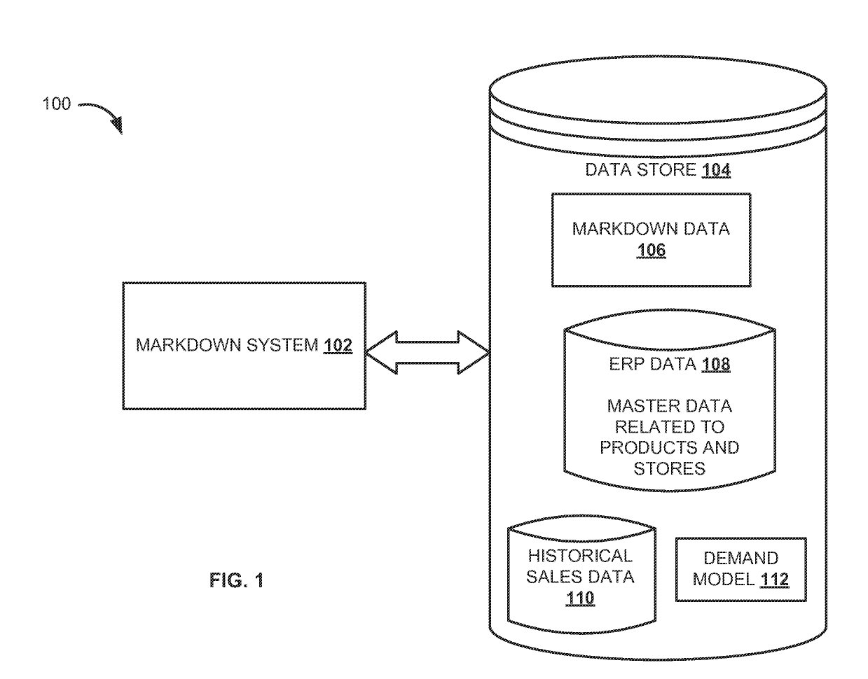

FIG. 1 is a block diagram of a system for generating an optimized result set for a problem, according to an embodiment. In an embodiment, system 100 includes markdown system 102 communicatively coupled to data store 104. Data store 104, stores data structures that include business data. Business data in the data structures may include markdown data 106 associated with products, Enterprise Resource Planning (ERP) data 108, historical sales data related to the products 110, demand curves predicting sales of the products represented by demand model 112, etc. In an embodiment, ERP data 108 may be analyzed to determine master data related to stores and products. The demand curves and historical sales data 110 associated with the product may be used to develop demand model 112, also referred to as standard demand model for the product. The standard demand model may provide a platform for determining markdown pricing and markdown schedule for the product representing markdown data 106 associated with the product.

In an embodiment, the markdown pricing for the product may be determined by markdown system 102. Markdown system 102 includes memory elements that store instructions to be executed by a processor of a computer (not shown) to generate optimized pricing for the product. For instance, the memory elements include instructions for implementing optimization algorithms. In an embodiment, the optimization algorithms may include genetic algorithms to optimize the markdown of products. The initial sets of pricing information may be generated from the master data related to stores, products, demand models, etc. The genetic algorithms receive the initial sets of pricing information as inputs and iteratively execute on the initial sets of pricing information to generate optimized prices representing optimized markdown data for the products. The optimized markdown data may include multiple sets of prices for the product and may represent particularly desirable result set including pricing information or a sizeable pricing set for the product.

Genetic Algorithm—Terms and Methodology

In an embodiment, a problem definition may be associated with an objective. Such a problem definition may be mapped to a genetic algorithm to generate optimized solution sets for the problem. Genetic algorithms may use evolutionary techniques, such as, selection, cross over, mutation, etc., to converge onto a particularly desirable result set representing optimized solution set for a problem. In an embodiment, a particularly desirable result set may be generated by using heuristic and meta-heuristic rules in conjunction with genetic algorithms. The genetic algorithms are iteratively executed on an initial set of solutions associated with a problem. The execution of the genetic algorithm iteratively reduces the number of the solutions associated with the problem to generate a particularly desirable result set. Such reduction may be referred to as convergence. The iterative execution may also be referred to as Monte Carlo method of execution.

The initial set of solutions may be generated by applying business rules and constraints on numerous set of solutions associated with the problem. The initial set of solutions may be referred to as an initial population that includes multiple sets of candidate solutions. In an embodiment, the candidate solutions in the population represent a generation. The genetic algorithm is iteratively executed on the candidate solutions to generate candidate solutions for successive generations. The successive generations of candidate solutions may iteratively converge to the particularly desirable result set.

In an embodiment, a candidate solution in a generation may be referred to as a chromosome. The candidate solution represents a design solution associated with the problem. The chromosome, thus representing the candidate solution, may include a string of numbers or an array of bits and stored in a data structure. Each chromosome has unique characteristics and parameters that may be modified by a process of mutation.

In an embodiment, mutation may refer to modifying or altering characteristics or parameters of the chromosomes. A chromosome in a generation may be mutated by modifying the characteristics of the chromosomes. Such a modification may include altering the characteristic of the chromosome with a desired characteristic so that the candidate solutions converge to particularly desirable result set. The chromosomes may be mutated to preserve diversity and prevent the chromosomes from becoming too similar to each other, thus slowing or even stopping evolution of chromosomes in successive generations. The chromosomes from the current generation may be selected to participate in a process of cross over for breeding chromosomes of successive generations based on fitness of the chromosomes. Fitness of the chromosome may refer to a figure of merit associated with the chromosome. The chromosome may be determined as fit by comparing the fitness score of the chromosome with a threshold value. If the fitness score is greater than or equal to the threshold value, the chromosome is determined as fit to participate in the process of breeding the chromosomes of the successive generations.

In an embodiment, crossover may refer to a process of generating candidate solutions in successive generations. Such successive generation or next-generation candidate solutions may also be referred to as child solutions. Crossing over of chromosomes or crossover of chromosomes may refer to a process of selecting chromosomes to breed new child solutions in successive generations. The chromosomes selected for crossover may represent elite chromosomes and may be referred to as parent chromosomes or elite parent chromosomes. In an embodiment, the parent chromosomes from a current generation may be selected based on a fitness score of the chromosomes. The fitness score of the chromosomes may be computed based on objective functions associated with the problem. The process of selecting the parent chromosomes based on the fitness score may be referred to as “Roulette Wheel Selection.” In Roulette wheel selection, the probability of selecting chromosomes is higher when the fitness score of the chromosomes is high.

In an embodiment, a genetic algorithm may be iteratively executed on each chromosome of each generation based on objective functions associated with the problem. The objective functions associated with the problem may be designed based on factors, for example, objective of the solution. The objective functions may also be referred to as fitness functions. A fitness function may evaluate a figure of merit of a candidate solution in a particular generation. The figure of merit indicates a degree of closeness of a candidate solution corresponding to the particularly desirable result set. For instance, in markdown optimization in retail, the retailers' objective may be to maximize profits or minimize the volume of inventory before the end of products' lifecycle. Accordingly, the fitness functions may be designed to achieve the desired objectives associated with the sale of the products.

In an embodiment, the fitness functions may also be designed based on the volume of inventory and elasticity of the product. Elasticity of the product may refer to measuring an effect of a variable change associated with the product. In other words, elasticity may refer to measuring how a change in the variable associated with the product affects other variables associated with the product. The product may be inelastic product or a highly price sensitive product. That is, a relatively small change of the price of the product may significantly change the sales of the product. For example, consider price and sales as variables that are associated with a cell phone. When the cell phone price is lowered, the sales of the cell phone may increase exponentially. In such a case, the variable change of lowering the price of the cell phone impacts the variable sales of the cell phone disproportionately. Such disproportionate measurements may be used to determine the elasticity of the product.

In an embodiment, in retail domain, the objective may be to minimize the inventory. For such objective, the associated problem definition may include strategies to maximize sales of the inventory such that the retailer achieves the desired objective of minimizing the inventory of the product at optimal price. Such optimal pricing may be achieved by mapping the problem to the genetic algorithm and generating optimized solutions based on the objectives.

In an embodiment, the execution of genetic algorithms on candidate solutions associated with the problem may generate a set of solutions that are better optimized or that converge to a particularly desirable result set. For instance, a problem of markdown of products, when mapped to a genetic algorithm generates a result set that includes markdown prices that are more optimal and converging to a particularly desirable set of optimized prices or desired prices for the product. The use of genetic algorithms provides the flexibility of configuring business rules, constraints, mutating and crossing over of chromosomes to aid convergence of candidate solutions, etc. The genetic algorithms may be developed and implemented using known programming techniques and programming languages in the art (for e.g. C, C++, Java, etc.).

Demand Model for Markdown

In an embodiment, a demand for a product may be analyzed via a standard demand model associated with the product. The standard demand model may also include prior retail prices of products including price sensitivity of the product to actual, promotional and previous markdown events. The standard demand model may include demand curves indicating a relation between the price of a product, volume of inventory, volume of sales for a particular price, etc. In an embodiment, a markdown schedule for the product may be derived from the standard demand model associated with the product. The standard demand model may also be used to determine a first retail markdown price for the product.

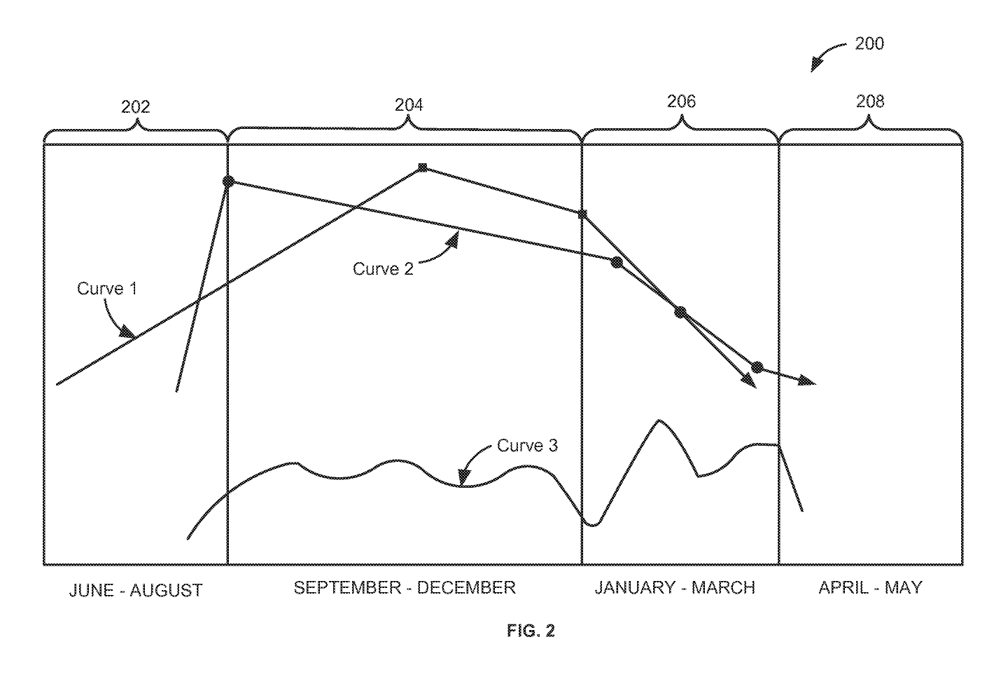

FIG. 2 is an exemplarily graphical illustration of demand curves associated with a product, according to an embodiment. FIG. 2 shows demand curves for jackets. The demand curves include information related to price of jackets, volume of inventory of the jackets and volume of sales for specific prices of the jacket. The x-axis represents a time period, which is grouped in months. For example, consider weather seasons in North America. The weather seasons may be grouped. For example, a first group corresponding to time period of June to August 202 that may represent summer season; a second group corresponding to time period of September to December 204 may represent fall season; a third group corresponding to a time period of January to March 206 may represent onset of winter/or peak winter season: and a fourth group corresponding to time period of April to May 208, may represent onset of autumn season. As exemplarily illustrated, a varying behavior in sales of the jackets may be observed corresponding to each time period.

As shown in FIG. 2, curve 1 represents volume of inventory of jackets; curve 2 represents change in price of the jackets: and curve 3 represents sales of jackets. As shown, towards the end of summer and onset of fall, an increase in price of jackets corresponding to time period of June to August 202, may be observed. Anticipating an increase in demand for the jackets, an increasing slope corresponding curve 1 indicates an increase in volume of inventory of jackets, corresponding to time period of September to December 204. It may also be observed that the volume of inventory indicates a gradual decrease in the inventory during the time period September to December 204, and a further decrease in the time period January to March 206.

The price of the jacket is highest at the onset of fall for time period corresponding to September to December 204, and a decrease in price for subsequent time periods may be observed. For instance, consider a markdown on the jackets that is scheduled to corresponding time period January to March 206. A first markdown may be scheduled at the beginning of January and a second markdown may be scheduled for February, and so on. It may be observed there is no marked change or increase in sales of the jackets in the time period corresponding to the markdown, as indicated by curve 3. It may be observed that curve 3 exhibits a fluctuating behavior for the time period between September and March.

In an embodiment, based on the standard demand model for the product, the markdown for the product may be scheduled. As explained above, by analyzing the price, volume of the inventory and volume of sales for a particular price, the markdown of inventory may be scheduled. The markdown may be scheduled based on elasticity of product and the objective, for example, of either maximizing the profit or minimizing the volume of inventory, before the end of the product life cycle.

Business Rules

In an embodiment, a user may define business rules that may impose constraints on a permissible markdown schedule. The permissible markdown schedule may be generated based on the standard demand model.

In an embodiment, a user defined business rule may impose a duration constraint. The duration constraint indicates the number of days for which the markdown schedule is planned. For example, a markdown schedule may be planned for 60 days by specifying a start date for the markdown and an end date for the markdown, thereby indicating the duration for markdown.

In an embodiment, the user defined business rule may impose a constraint on minimum days and maximum days between the markdowns. When there are two or more markdown steps, the time between them can be limited to a specified range. For example, a vendor may offer to sell a camera with 15% off on an actual price of the camera. Using this rule, the vendor may offer to sell the camera at 15% off on the actual price for a minimum of 3 days and a maximum of 5 days, 20% off on the actual price for the minimum of next 3 days and the maximum of 5 days, and so on.

In an embodiment, a user defined business rule may impose a constraint on a maximum percentage permissible for a first markdown in the markdown schedule. For example, a vendor may be willing to sell a cell phone at 25% discount on the actual price. However, if the constraint defined on the maximum percentage permissible for the first markdown is 20%, then such constraint would prevent the vendor from offering 25% discount as the first markdown in the markdown schedule.

In an embodiment, a user defined business rule may impose a constraint on the minimum price change and maximum price change in the markdown schedule. This rule will impose a limit on a least acceptable product price and also improve the process of optimizing the markdown of product.

In an embodiment, a user defined business rule may impose a constraint on a minimum and maximum number of markdowns. The markdown solution for each schedule group can be a sequence of discrete steps in price.

In an embodiment, a user defined business rule may impose a constraint on minimum and maximum change in percent off at each markdown. Each step in the markdown involves a price reduction as some percentage of actual prices. This rule limits the range of price drop at each step.

In an embodiment, a user defined business rule may impose a constraint on a minimum and maximum percent off on the actual price. Once there is a markdown from actual price, there may be a limit on the minimum and maximum discounted prices in terms of their percentage off actual price.

In an embodiment, a user defined business rule may impose a constraint on minimum and maximum days for the last markdown. The last markdown may have limits on its duration, which can be different from the time intervals between markdown steps.

In an embodiment, a user defined business rule may impose a constraint on an allowed percent off for the markdown. A list of allowed percent off may be used. For example, allowed percent off may include 10%, 15%, 20%, 30%, and so on.

Markdown Optimization for a combination of single product and single store.

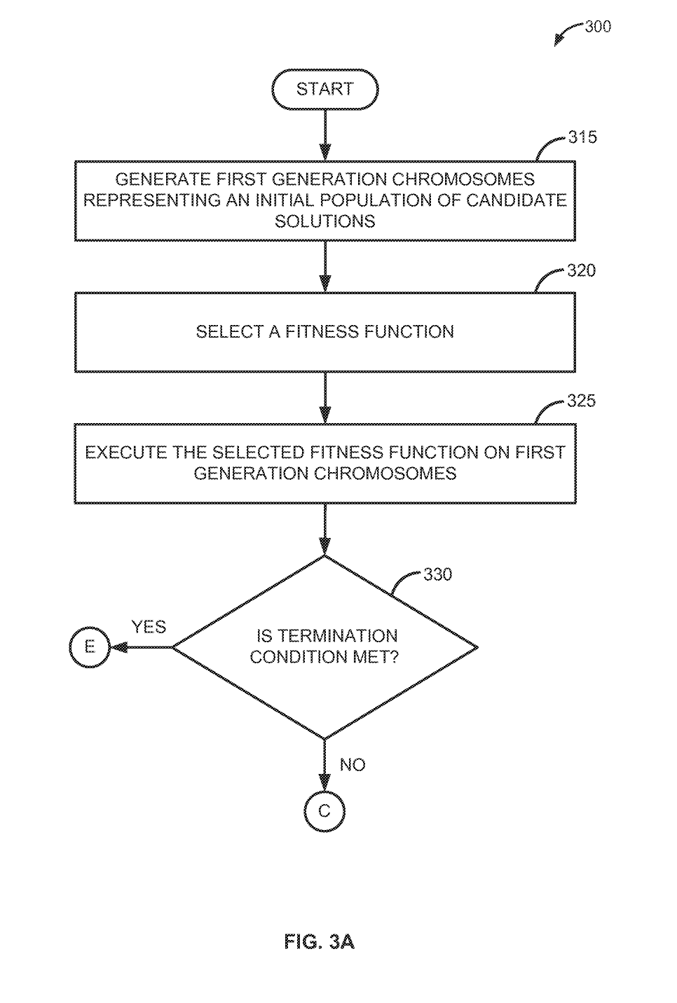

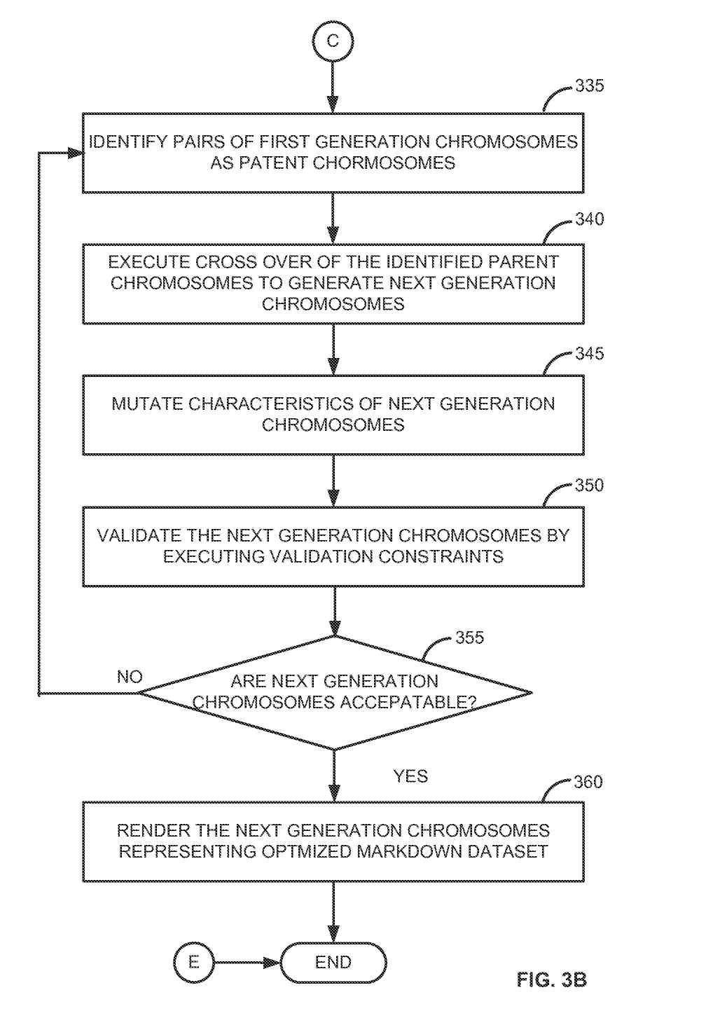

FIG. 3A and FIG. 3B are flow diagrams illustrating a process for generating optimized markdown data, according to an embodiment. In an embodiment, a markdown may be optimized by mapping the markdown process to a genetic algorithm. For such optimization, a combination of single product and single store is considered, according to an embodiment. Upon execution of genetic algorithm as described in process 300, optimized candidate solutions or optimized markdown dataset are generated. The optimized markdown dataset may be represented by the chromosomes that have converged to a particularly desirable result set. Based on a configured set of business rules, an initial population of chromosomes is generated, at 315. The initial population of chromosomes corresponds to a number of sets of pricing solutions associated with the product. The initial population of chromosomes is generated by applying business rules or constraints on a large set of pricing solutions. The large set of pricing solutions may be generated from historical sales data, duration in days for each markdown, previous markdown data represented by the percentage of discount offered, etc., associated with the product. The large set of pricing solutions may be represented by a large set of population of chromosomes. In an embodiment, the initial population of chromosomes may also be referred to as first generation chromosomes. The pricing information associated with the product may be represented by a tree structure. The tree structure may include multiple branches indicating information including actual pricing, markdown or percentage of discount offered on the product, duration in days for each markdown, etc., associated with the product.

In an embodiment, based on the objective of markdown, an objective function or a fitness function is selected at 315. The objective of markdown may include maximizing the profits or minimizing the volume of inventory before the end of the product's lifecycle. The fitness function may be designed based on the elasticity of the product and the volume of inventory associated with the product. For instance, the estimated profit can be maximized by selecting the corresponding fitness margin score function/equation and executing the selected fitness margin score function/equation on the chromosomes. The fitness score of each chromosome in the population may be computed using a fitness margin score defined by the equation:

Fitness Margin Score=(I₀*C_{P})−((I₀−Σᵢ₌₁^{m}Sᵢ*Dᵢ)*Cₛ+Σᵢ₌₁^{m}Pᵢ*Sᵢ*Dᵢ) equation (1)

In an embodiment, the volume of inventory can be minimized by selecting the fitness inventory score function/equation and executing the selected fitness margin score function/equation on the chromosomes. The fitness score of each chromosome in the population may be computed using a fitness inventor score defined by the equation:

Fitness Inventory Score=(I₀−Σᵢ₋₁^{m}Sᵢ*Dᵢ) equation (2)

In the equations (1) and (2) above, ‘I₀’ represents initial inventory of a product; ‘m’ represents number of markdown steps scheduled; ‘Dᵢ’ represent number of days in the i^{th} markdown day; ‘Pᵢ’ represents selling price set for the markdown step “i.” Selling price remains constant (for e.g. ‘Pᵢ’) for the days within the markdown step; ‘Cₚ’ represents the cost of procurement of product; ‘Cₛ’ represents the salvage price set for the product; ‘Sᵢ’ represents projected sales per day for the markdown step “i”, which remains constant for the days within the markdown step.

In an embodiment, when the objective is to maximize profit, a high fitness score of the chromosome may represent convergence to a particularly desirable result set. When the objective is to minimize the volume of inventory, a lower fitness score of the chromosome may represent convergence to a particularly desirable result set.

In an embodiment, the selected fitness function is executed on the first generation chromosomes, at 325. The execution of the fitness function on a chromosome computes the fitness score of the chromosome in a generation. The computed fitness score may be compared with a threshold value to determine the fitness of chromosome. Fitness of chromosome is determined to evaluate or investigate if the chromosomes are fit to breed successive generations. On computing the fitness score, a genetic algorithm termination condition may be evaluated, at 330. For instance, the termination condition may include a predetermined number of times of iterative execution of the genetic algorithm on the initial population, generation of result set that is close to the desirable result set, etc. If the result of evaluation is true (indicated by ‘YES’ in FIG. 3A), the genetic algorithm terminates execution (indicated by ‘E’ in FIGS. 3A-3B). If the result of evaluation is false (indicated by ‘NO’ in FIG. 3A), process 300 moves to 335, where based on the fitness score, a pair of chromosomes or pair of strings of chromosomes are identified as parent chromosomes. A crossover of the parent chromosomes is executed to breed new chromosomes in the successive generation, at 340. Such newly bred chromosomes in the successive generations or next-generations may be referred to as child chromosomes and may represent child solutions. The child chromosomes may include the characteristics of the parent chromosomes.

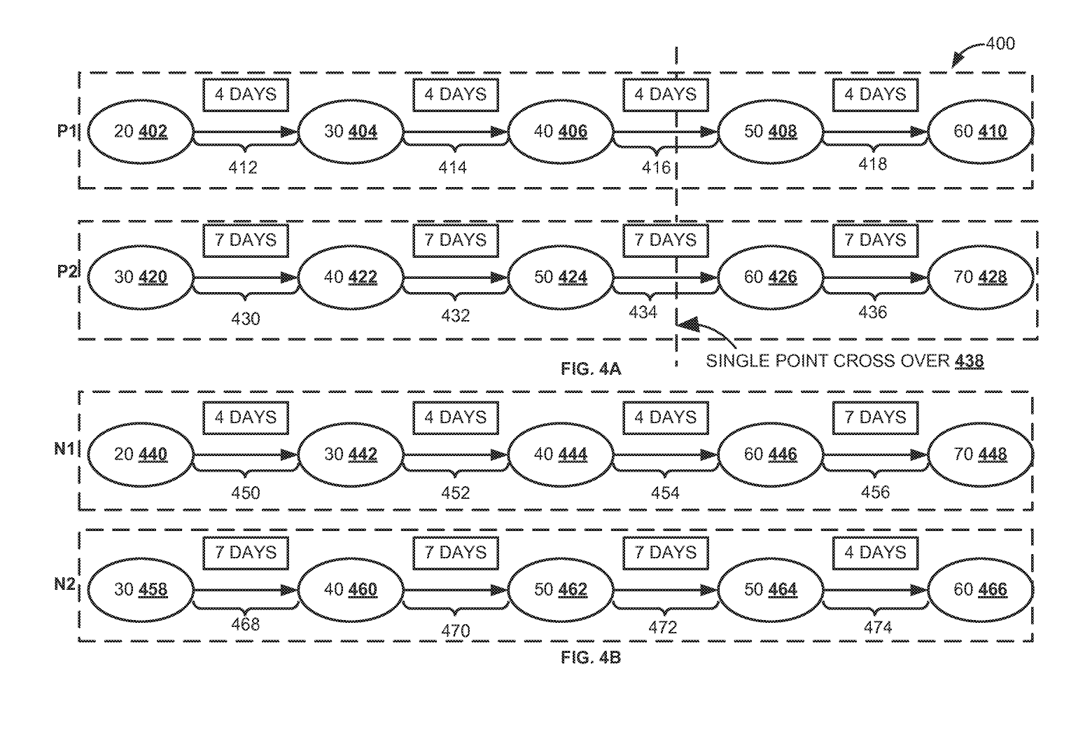

FIGS. 4A-4B are block diagrams illustrating a one-point crossover on a pair of strings of chromosomes according to an embodiment. Successive generations of chromosomes may be bred from current generation of chromosomes. As explained above, parent chromosomes are identified from the current generation and selected for breeding child chromosomes for successive generations. In an embodiment, a single point crossover may be chosen on parent chromosomes when there are a limited number of markdown steps in a markdown schedule or solution. Single point crossover simplifies the execution of genetic algorithm. FIG. 4A shows a single point crossover 438 on the pair of strings of parent chromosomes P1 and P2. 402-410 and 420-428 represent the chromosomes including characteristics or parameters (indicated by numbers 20, 30, 40 etc.). 412-418 and 430-436 also represent the characteristics or parameters (indicated by 4 days, 7 days, etc.). All characteristics or parameters of the parent chromosomes P1 and P2 beyond the single point crossover 438 are swapped. For instance, 408, 418 and 410 of P1 are swapped with 426. 436 and 428 of P2. The crossover resultant may be referred to as child chromosomes or offspring candidate solutions, represented by N1 and N2. As shown in FIG. 4B, the characteristics of N1 (indicated by 446, 456 and 448) and N2 (464, 474, and 466) beyond the single point crossover 438 are the resultant of swapping.

Referring back to process 300 in FIGS. 3A-3B, the characteristics of the crossed over or next-generation chromosomes may be determined. Based on such determination, the characteristics of chromosomes are mutated, at 345. Mutation may refer to a process of modifying parameters or characteristics of the chromosomes. For example, in markdown optimization, a chromosome may represent a markdown percentage and a line between two chromosomes may represent duration in days for markdown.

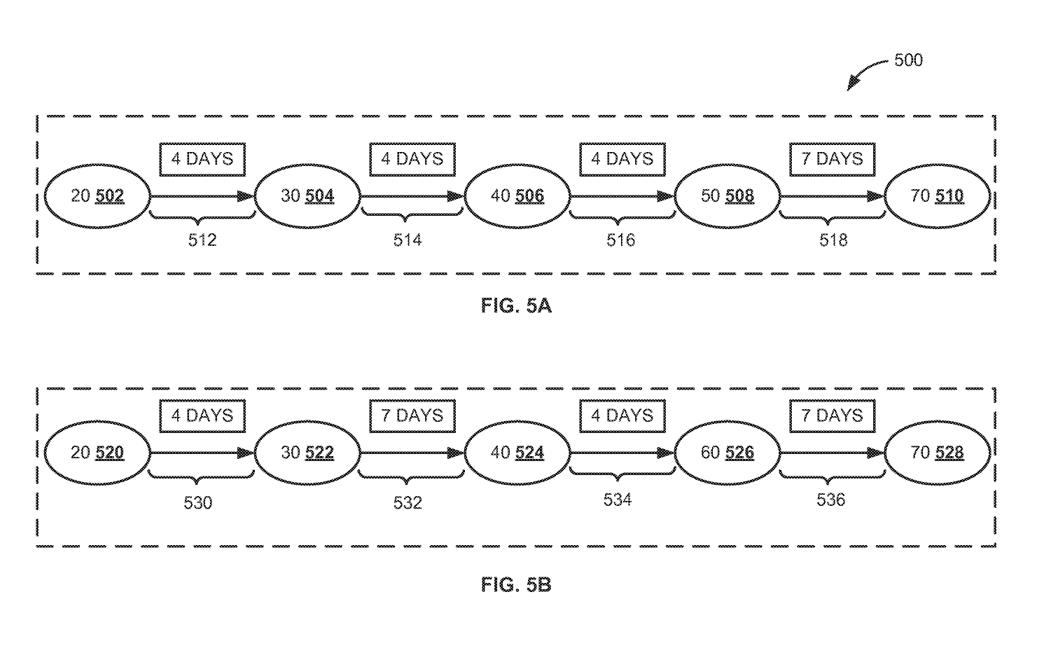

FIGS. 5A-5B are block diagrams exemplarily illustrating a process of mutation, according to an embodiment. As exemplarily illustrated, FIG. 5A shows a string of chromosomes, where each chromosome represents a markdown percentage (indicated by 502, 504, 506, 508 and 510) and lines between the chromosomes (indicated by 512, 514, 516 and 518) representing duration in days between the markdown percentages. Mutation may include adding chromosomes, deleting chromosomes, modifying parameters or characteristics of chromosomes, etc. For instance, FIG. 5B shows execution of mutation of chromosome by adding a chromosome to the string of chromosomes in FIG. SA and modifying or altering desired characteristic or parameter of the chromosomes. As exemplarily illustrated in FIG. 5B, chromosome with markdown percentage (indicated by 526) is added to the string of chromosomes (indicated by 502, 504, 506, 508 and 510). Further the duration in days (indicated by 514, between the chromosomes 504 and 506) is mutated or modified (indicated by 532, between the chromosomes 522 and 524). In an embodiment, mutation is applied to chromosomes where an incorrect candidate solution is identified. The incorrect candidate solution may be mutated by desired characteristics to correct the inaccurate candidate solution and enable convergence to a particularly desirable result set.

In an embodiment, the candidate solutions represented by the chromosomes may be mutated at any step or any stage during the markdown schedule. In markdown optimization, volume of inventory of a product and elasticity of the product plays a significant role in determining the parameter to be mutated and the stage or step during which the chromosome may be mutated. For example, the parameter that may be mutated in markdown optimization may include the markdown or percentage discount offered on the actual price, increase or decrease of durations between two successive markdowns, etc.

In an embodiment, when the objective is, for example, to minimize the volume of inventory, the chromosome may be mutated before the end of markdown. The heuristic rules or heuristic information for making such determination may include: the product is highly elastic or not; the volume of inventory; the probability for not selling a particular volume of the inventory by the end of products' lifecycle; etc. Based on such information, the discount offered on the product may further be increased to achieve the objective of minimizing the volume of inventory before the end of markdown period.

In an embodiment, when the objective is, for example, to minimize the volume of inventory, the chromosome may be mutated at an intermediate stage or step of markdown. The heuristic rules/heuristic information for making such determination may include: the product is highly elastic or not: the probability for not selling a particular volume of inventory even if the duration of markdown is increased; etc., then the discount percentage or markdown offered on the product may be increased immediately to minimize the volume inventory. Based on such information, the discount offered on the product may further be increased immediately to achieve the objective of minimizing the volume of inventory.

In an embodiment, when the objective is for example, to minimize the volume of inventory, the chromosome may be mutated at the beginning of markdown. The heuristic rules/heuristic information for making such determination may include: the product is highly elastic and the inventory is minimizing before the start of markdown; and/or product is in-elastic; maximum markdown may be offered to initiate increase in sales, etc. Based on such information, the discount offered on the product may further be increased to achieve the objective of minimizing the volume of inventory at the beginning of markdown.

The above heuristic rules/heuristic information is used for illustrative purposes. Other combination of heuristic rules or heuristic information may also be used to determine the stage or step or characteristic of chromosome that may be mutated.

Referring back to FIGS. 3A-3B, the particularly desirable result set represented by the next generation chromosomes may be validated, at 350. In an embodiment, a set of constraints or business rules may be used to validate the particularly desirable optimized result set. For instance, in optimizing markdown, business rules and constraints associated with validation may include a minimum price of sale of a product, cost incurred for handling inventory and operations during each stage/step of the markdown, a budget constraint that may keep a check on total expenses incurred for minimizing the inventory, constraints related to inventory management, etc.

In an embodiment, the particularly desirable result set of chromosomes may be validated against a budget constraint. The budget constraint may be enforced to regulate the total expenses for the markdown event. For instance, the total expenses for the markdown event may be equivalent to the cost at every step of the markdown period for the given product. The budget constraint may be enforced by using the equation:

$${\sum }_{i = 1}^{M} {C}_{{m}_{i}} \leq {T}_{MB} \qquad equation ( 3 )$$

In the equation above, Cm, represents markdown price change at ‘i^{th}’ step; ‘M’ represents number of steps for which the markdown is scheduled; and T_{MB} represents markdown budget allocated for a product markdown.

In an embodiment, the particularly desirable set of chromosomes may be validated against inventory constraint. The inventory constraint is enforced to prevent exceeding the maximum volume inventory. The inventory constraint may be enforced based on the equation:

$${I}_{0} - {\sum }_{i = 1}^{M} {S}_{i} * {D}_{i} \geq 0 \qquad equation ( 4 )$$

In the above equation, ‘I₀’ represents initial inventory of a product; ‘M’ represents number of steps for which the markdown is scheduled; ‘Dᵢ’ represents number of days in the i^{th} markdown step; ‘Sᵢ’ represents projected sales per day for the markdown step “i”, which remains constant (for e.g. ‘Sᵢ’) for the markdown period.

Upon validation and determined as acceptable, the next generation chromosomes represent particularly desirable result set, at 355. If the next generation chromosomes are not acceptable (indicated by NO in FIG. 3B), process 300 moves to 335. If the next generation chromosomes are acceptable (indicated by YES in FIG. 3B), the next generation chromosomes are rendered as optimized markdown dataset, at 360. Process 300 ends execution at to generate optimized markdown data. In an embodiment, steps 325 to 360 may repeat execution or iteration for the entire set of initial population of chromosomes. The validated set of candidate solutions or chromosomes representing the particularly desirable result set are retained.

Markdown Optimization for a Combination of Multiple Products and/or Multiple Stores

In an embodiment, a problem of a markdown for products may be optimized by mapping the problem to a genetic algorithm. For such optimization, a combination of multiple products and multiple stores is considered, according to an embodiment. A product manufacturer or a wholesale distribution center may supply multiple products to multiple stores. Clusters of related products and stores associated with the distribution center may be generated or created. The criteria for clustering related products may be based on product classification of product group, product family, elasticity, etc. The genetic algorithm may be iteratively executed on each cluster simultaneously or in parallel to generate a particularly desirable result set or optimized result set for each cluster. Based on the optimized result set corresponding to each cluster, a common markdown schedule may be implemented for the combination of products and stores corresponding to each cluster.

In an embodiment, a combination of products and stores for which markdown is scheduled may be selected. The business rules and constraints as explained above are applicable to multiple products and/or multiple store combination. For instance, the business rules and constraints may be applied to create initial population of candidate solutions for the multiple stores and/or multiple product combination. In an embodiment, additional constraints and business rules may also be defined. For instance, business rules and constraints specific to clusters of products, specific to different products in the cluster, etc., may be defined. In one embodiment, the genetic algorithm executes on multiple clusters simultaneously to create or generate particularly desirable result set corresponding to each cluster.

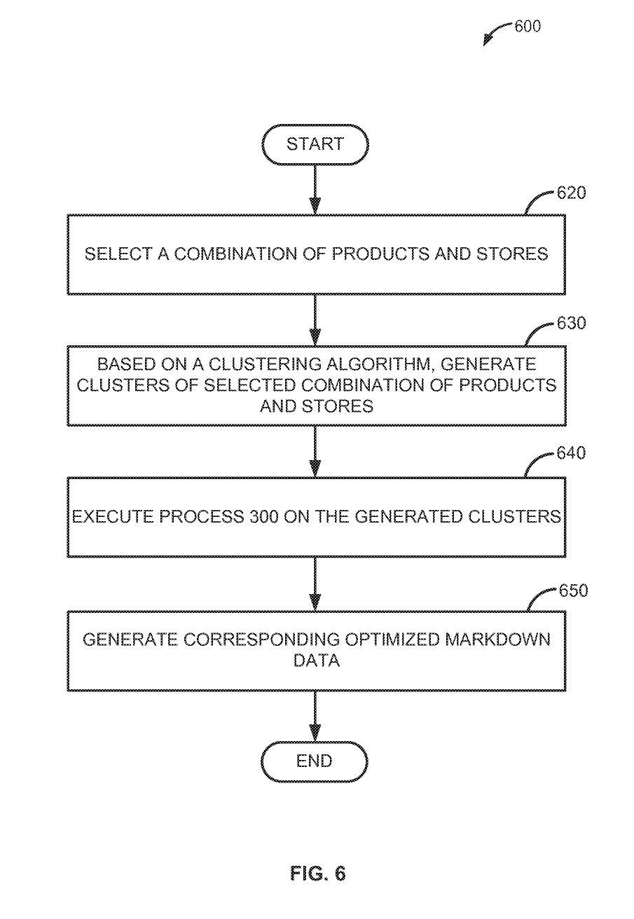

FIG. 6 is a block diagram illustrating process 600 to generate optimized markdown data, according to an embodiment. In an embodiment, upon execution of process 600, optimized candidate solutions corresponding to each cluster that includes a combination of products and stores is generated. A combination of products and stores is selected, at 620. Based on a clustering algorithm, clusters or groups of combinations of products and stores are generated, at 630. Upon clustering a combination of products and stores process 300 is executed on the generated clusters, at 640. Corresponding optimized markdown data is generated, at 650.

In an embodiment, the objective of markdown may include maximizing the profits or minimizing the volume of inventory before the end of the product's lifecycle.

The fitness function may be designed or defined based on the elasticity of the product and the volume of inventory associated with the product. For instance, the estimated profit can be maximized by selecting the corresponding fitness margin score function/equation and executing the selected fitness margin score function/equation on the chromosomes. The fitness score of a chromosome in the cluster may be computed using a fitness margin score defined by the equation:

Fitness Margin Score=(Σₖ₌₁^{h}I₀_{ₖ}*C_{P}_{ₖ})−((Σₖ₌₁^{h}I₀_{ₖ}−Σⱼ₌₁ⁿΣₖ₌₁^{h}Σᵢ₌₁^{m}(S_{k,i}^{j}*Dᵢ)) C_{S}_{ₖ}+Σⱼ₌₁ⁿΣₖ₌₁^{h}Σᵢ₌₁^{m}(P_{k,i}^{j}*S_{k,i}^{j}*Dᵢ)) equation (5)

In an embodiment, the volume of inventory can be minimized by selecting the fitness inventory score function and executing the selected fitness margin score function/equation on the chromosomes. The fitness score of a chromosome in the population may be computed using a fitness inventor score defined by the equation:

Fitness Inventory Score=(Σₖ₌₁^{h}I₀_{ₖ}−Σⱼ₌₁ⁿΣₖ₌₁^{h}Σᵢ₌₁^{m}(S_{k,i}^{j}*Dᵢ)) equation (6)

In the equations (5) and (6) above ‘n’ represents number of stores in a cluster; ‘h’ represents number of unique products in a cluster; ‘m’ represents number of markdown steps in a cluster; ‘I₀_{ₖ}’ represents initial inventory of product ‘k’ within the selected cluster stores and distribution centers; ‘Dᵢ’ represents number of days in the i^{th} markdown step; ‘C_{P}_{ₖ}’ represents cost of procuring the product ‘k’; ‘C_{S}_{ₖ}’ represents the salvage cost the product ‘k’; ‘S_{k,i}^{j}’ represents per day sales for k^{th} product and j^{th} store in a cluster, for the i^{th} markdown step; P_{k,i}^{j}′ represents the price of k^{th} product and j^{th} store in a cluster for the i^{th} markdown step.

In an embodiment, the selected fitness function is executed on each chromosome in a generation to compute the fitness score (e.g., as explained in detailed description of FIGS. 3A-3B). Steps similar to the steps 325 to 360 of process 300 as explained in the context of FIGS. 3A-3B, may be executed on each cluster.

In an embodiment, the particularly desirable result set of chromosomes in each cluster may be validated against a budget constraint. The budget constraint may be enforced to regulate the total expenses for the markdown event. For instance, the total expenses for the markdown event may be equivalent to the cost at every step of the markdown period for the given product. The budget constraint may be enforced by using the equation:

$${\sum }_{j = 1}^{n} {\sum }_{k = 1}^{h} {\sum }_{i = 1}^{m} {C}_{{m}_{k , i}}^{j} \leq {T}_{MB} \qquad equation ( 7 )$$

In the equation above, ‘n’ represents total number of stores in cluster; ‘h’ represents number of unique products in a cluster; ‘m’ represents number of markdown steps of a cluster; ‘Cₘ_{_{k,i}}^{j}’ represents markdown price change in each step of a product and store combination. ‘T_{MB}’ represents markdown budget allocated for a cluster, which is computed even if a consolidated budget was allocated.

In an embodiment, the particularly desirable set of chromosomes in each cluster may be validated against inventory constraint. The inventory constraint is enforced to prevent exceeding the maximum volume inventory. The inventory constraint is enforced using the equation:

$${I}_{0 , j} - {\sum }_{j = 1}^{n} {\sum }_{k = 1}^{h} {\sum }_{i = 1}^{m} ( {S}_{k , i}^{j} * {D}_{i} ) \geq 0 \qquad equation ( 8 )$$

In the equation above, ‘I_{0,j}’ represents initial inventory of a product ‘j’; ‘n’ represents total number of stores in cluster: ‘h’ represents number of unique products in a cluster; ‘m’ represents number of markdown steps of a cluster; ‘S_{k,i}^{j}’ representing the sales units for j^{th} product for a i^{th} step of markdown in the k^{th} store; and ‘Dᵢ’ represents number of days in the i^{th} markdown step.

In an embodiment, process 600 upon execution generates optimized markdown data corresponding to each cluster.

In an embodiment, clusters combination of products and stores may be generated by using a standard clustering algorithm. For instance, a hierarchical clustering algorithm may execute to generate a cluster or group of stores associated with the distribution center. Clustering is based on the geographical proximity of the stores and distribution center. The hierarchical clustering algorithm is executed on such clusters of stores to identify the products therein. The identified products are grouped or clustered with the stores to generate clusters of combination of the products and the stores. Such clusters of the combination of products and stores may be mapped to genetic algorithm to generate optimized markdown data corresponding to the clusters.

In an embodiment, additional business rules and constraints related to products and stores may be applied to generate or create clusters including the combination of products and stores. For example, the business rules may include information related to number of products and stores associated with the distribution center, category of product, product family, elasticity of product, geographical region of the store, etc. may be configured to determine the combination of products and stores in the cluster.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

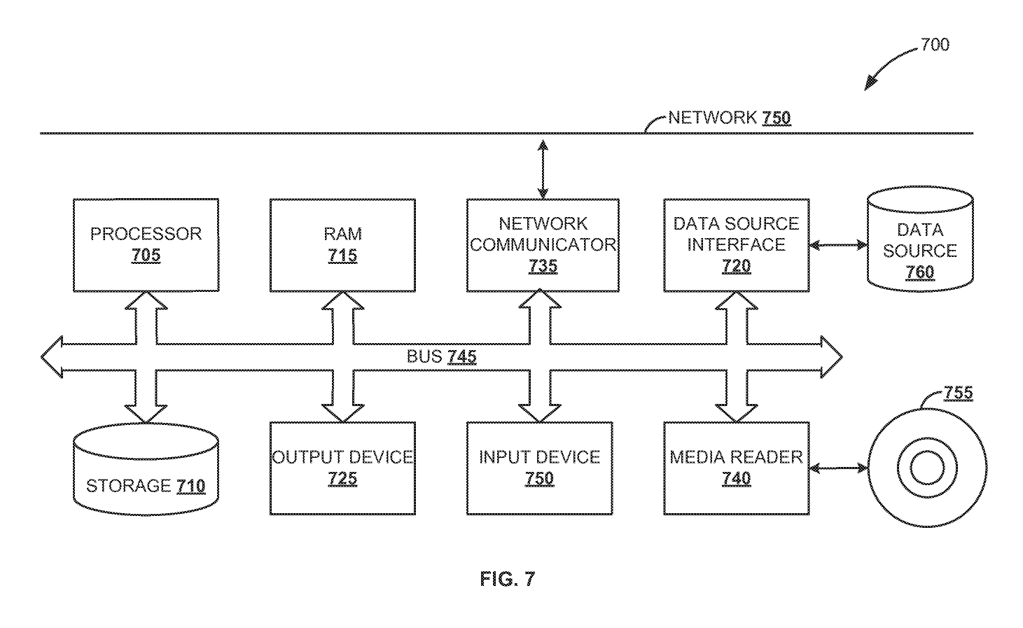

FIG. 7 is a block diagram of an exemplary computer system 700, according to an embodiment. Computer system 700 includes processor 705 that executes software instructions or code stored on computer readable storage medium 755 to perform the above-illustrated methods. Processor 705 can include a plurality of cores. Computer system 700 includes media reader 740 to read the instructions from computer readable storage medium 755 and store the instructions in storage 710 or in random access memory (RAM) 715. Storage 710 provides a large space for keeping static data where at least some instructions could be stored for later execution. According to some embodiments, such as some in-memory computing system embodiments, RAM 715 can have sufficient storage capacity to store much of the data required for processing in RAM 715 instead of in storage 710. In some embodiments, all of the data required for processing may be stored in RAM 715. The stored instructions may be further compiled to generate other representations of the instructions and dynamically stored in RAM 715. Processor 705 reads instructions from RAM 715 and performs actions as instructed. According to one embodiment, computer system 700 further includes output device 725 (e.g., a display) to provide at least some of the results of the execution as output including, but not limited to, visual information to users and input device 730 to provide a user or another device with means for entering data and/or otherwise interact with computer system 700. Each of these output devices 725 and input devices 730 could be joined by one or more additional peripherals to further expand the capabilities of computer system 700. Network communicator 735 may be provided to connect computer system 700 to network 750 and in turn to other devices connected to network 750 including other clients, servers, data stores, and interfaces, for instance. The modules of computer system 700 are interconnected via bus 745. Computer system 700 includes a data source interface 720 to access data source 760. Data source 760 can be accessed via one or more abstraction layers implemented in hardware or software. For example, data source 760 may be accessed by network 750. In some embodiments data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system. XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to generate an optimized markdown dataset, comprising:
based on one or more business rules associated with a markdown for a product, generating a plurality of first generation chromosomes representing an initial population of one or more candidate solutions;
based on one or more objectives associated with the markdown, receiving a selection of at least one fitness function from a plurality of fitness functions;
executing, by a computer, the selected fitness function on the first generation chromosomes to compute a corresponding fitness score;
based on the computed fitness score, identifying one or more pairs of the first generation chromosomes as parent chromosomes;
executing a crossover of the identified parent chromosomes to generate one or more next-generation chromosomes;
based on a determination of one or more characteristics of the one or more next-generation chromosomes, mutating at least one characteristic of at least one next-generation chromosome;
based on the mutation, validating, by the computer, the at least one next-generation chromosome by executing one or more constraints corresponding to the validation to render the one or more next-generation chromosomes representing the optimized markdown dataset.

2. The computer implemented method of claim 1, further comprising: iterating the generation of the one or more next-generation chromosomes representing the optimized markdown dataset for the first generation chromosomes.

3. The computer implemented method of claim 1, wherein the parent chromosomes are identified by comparing the fitness score of the first generation chromosomes with a threshold value.

4. The computer implemented method of claim 1, wherein the plurality of fitness functions include a fitness margin score function and a fitness inventory score function.

5. The computer implemented method of claim 1, wherein the one or more characteristics of the next-generation chromosomes includes at least one characteristic of the parent chromosomes.

6. The computer implemented method of claim 1, wherein mutation comprises at least one of:
modifying the at least one characteristic of the next-generation chromosome;
adding one or more chromosomes in the next-generation chromosomes with at least one desired characteristic; and
deleting one or more chromosomes in the next-generation chromosomes.

7. The computer implemented method of claim 1, wherein the plurality of fitness functions are designed based on elasticity of a product and volume of inventory of product.

8. The computer implemented method of claim 1 further comprising: a standard demand model for deriving a markdown schedule, the execution of markdown schedule generating the optimized markdown dataset.

9. The computer implemented method of claim 1, wherein the one or more constraints corresponding to the validation includes a budget constraint, and an inventory constraint.

10. A computer implemented method to generate an optimized markdown dataset, comprising:
receiving a selection of a combination of one or more products and one or more stores;
based on a clustering algorithm, generating one or more clusters of the selected one or more combinations of the one or more products and one or more stores;
based on one or more business rules associated with a markdown for a product, generating a plurality of first generation chromosomes corresponding to the one or more clusters, the plurality of first generation chromosomes representing an initial population of one or more candidate solutions;
based on one or more objectives associated with the markdown, receiving a selection of at least one fitness function from a plurality of fitness functions for the clusters;
executing, by a computer the selected fitness function on the first generation chromosomes to compute a corresponding fitness score corresponding to the clusters;
based on the computed fitness score, identifying one or more pairs of the first generation chromosomes as parent chromosomes corresponding to the clusters;
executing a crossover of the identified parent chromosomes for the clusters to generate one or more next-generation chromosomes corresponding to the clusters;
based on a determination of one or more characteristics of the one or more next-generation chromosomes, mutating at least one characteristic of at least one next-generation chromosome corresponding to the clusters;
based on the mutation, validating, by the computer, the at least one next-generation chromosome by executing one or more constraints corresponding to the validation for the clusters to render the one or more next-generation chromosomes representing the optimized markdown dataset for the clusters.

11. The computer implemented method of claim 10, wherein the parent chromosomes are identified by comparing the fitness score of the first generation chromosomes corresponding to the clusters with a threshold value.

12. The computer implemented method of claim 10, wherein the plurality of fitness functions corresponding to the clusters includes a fitness margin score function and a fitness inventory score function.

13. The computer implemented method of claim 10, wherein mutation comprises at least one of:
modifying the at least one characteristic of the next-generation chromosome corresponding to the clusters;
adding one or more chromosomes in the next-generation chromosomes corresponding to the clusters with at least one desired characteristic; and
deleting one or more chromosomes in the next-generation chromosomes corresponding to the clusters.

14. The computer implemented method of claim 10, wherein the plurality of fitness functions are designed based on elasticity of a product and volume of inventory of product.

15. A non-transitory computer readable storage medium tangibly storing instructions, which when executed by a computer, cause the computer to execute operations comprising:
based on one or more business rules associated with a markdown for a product, generate a plurality of first generation chromosomes representing an initial population of one or more candidate solutions;
based on one or more objectives associated with the markdown, receive a selection of at least one fitness function from a plurality of fitness functions;
execute the selected fitness function on the first generation chromosomes to compute a corresponding fitness score;
based on the computed fitness score, identify one or more pairs of the first generation chromosomes as parent chromosomes;
execute a crossover of the identified parent chromosomes to generate one or more next-generation chromosomes;
based on a determination of one or more characteristics of the one or more next-generation chromosomes, mutate at least one characteristic of at least one next-generation chromosome;
based on the mutation, validate the at least one next-generation chromosome by executing one or more constraints corresponding to the validation to render the one or more next-generation chromosomes representing the optimized markdown dataset.

16. The non-transitory computer readable storage medium of claim 15 storing instructions, which when executed by the computer, cause the computer to execute operations further comprising:
generate the optimized markdown dataset for a cluster of one or more products and one or more stores by:
receiving a selection of a combination of one or more products and one or more stores;
based on a clustering algorithm, generating one or more clusters including the selected one or more combinations of the one or more products and one or more stores; and
rendering the one or more next-generation chromosomes representing the optimized markdown dataset for the one or more clusters.

17. The non-transitory computer readable storage medium of claim 15, wherein the parent chromosomes are identified by comparing the fitness score of the first generation chromosomes with a threshold value.

18. The non-transitory computer readable storage medium of claim 15, wherein the one or more characteristics of the next-generation chromosomes includes at least one characteristic of the parent chromosomes.

19. A computer system to generate an optimized markdown dataset, comprising:
a processor; and
one or more memory devices communicatively coupled with the processor and the one or more memory devices storing instructions to:
based on one or more business rules associated with a markdown for a product, generating a plurality of first generation chromosomes representing an initial population of one or more candidate solutions;
based on one or more objectives associated with the markdown, receiving a selection of at least one fitness function from a plurality of fitness functions;
executing the selected fitness function on the first generation chromosomes to compute a corresponding fitness score;
based on the computed fitness score, identifying one or more pairs of the first generation chromosomes as parent chromosomes;
executing a crossover of the identified parent chromosomes to generate one or more next-generation chromosomes;
based on a determination of one or more characteristics of the one or more next-generation chromosomes, mutating at least one characteristic corresponding to at least one next-generation chromosome:
based on the mutation, validating the at least one next-generation chromosome by executing one or more constraints corresponding to the validation to render the one or more next-generation chromosomes representing the optimized markdown dataset.

20. The computer system of claim 19, further comprising: generating the optimized markdown dataset for a cluster of one or more products and one or more stores by:
receiving a selection of a combination of one or more products and one or more stores;
based on a clustering algorithm, generating one or more clusters including the selected one or more combinations of the one or more products and one or more stores; and
rendering the one or more next-generation chromosomes representing the optimized markdown dataset for the one or more clusters.
